(19) United States
(12) Patent Application Publication
(10) Pub. No.: US 2007/0259288 A1
(43) Pub. Date: Nov. 8, 2007

(54) OPTICAL RECORDING MEDIUM AND METHOD OF PRODUCING THE SAME

(75) Inventor: Ryuichi Yokoyama, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/742,629

(22) Filed: May 1, 2007

(30) Foreign Application Priority Data
May 2, 2006 (JP) 2006-128398

(51) Int. Cl. G11B 7/24

(52) U.S. Cl. 430/270.11

(57) ABSTRACT

Provided are an optical recording medium having a multi-layer structure and a method of producing the optical recording medium, in which an adhesive layer or a hardening resin layer in a high-quality optical recording medium having the multi-layer structure can be formed at low cost with signal pattern transferability of a hardening resin layer enhanced. Specifically, an optical recording medium includes an adhesive layer or a hardening resin layer having a signal pattern surface formed by irradiating a hardening resin with an energy line. The hardening resin layer is formed by using a hardening resin containing at least two kinds of photopolymerization initiators having different absorbing wavelength ranges.

### BACKGROUND OF THE INVENTION

1. Field of the Invention

The present invention relates to an optical recording medium having a multi-layer structure including a plurality of reflective layers or recording layers, and to a method of producing the optical recording medium.

2. Description of the Related Art

In recent years, an optical recording medium is being applied as a recording medium for recording various kinds of information in a computer field, an audiovisual field, and the like. Further, along with the widespread use of mobile computers and the diversification of information, there is a demand for a small-sized optical recording medium with a large capacity.

Formed on a substrate of the above-mentioned optical recording medium for optically recording or reproducing information are pits and pregrooves for obtaining a tracking servo signal, and a fine uneven pattern (referred to as a signal pattern) of data information. As the above-mentioned optical recording medium, there is an optical recording medium having a single plate structure in which a recording layer or a reflective layer is formed on a substrate, and an organic protective layer is further formed, or an optical recording medium having an attached structure in which two substrates are attached with recording layers opposed to each other or reflective layers opposed to each other.

Further, along with a demand for increased density, a recording medium in which a plurality of recording layers are formed on one substrate surface is proposed. Only one recording layer is formed on one substrate surface in the above-mentioned recording medium having the single plate structure and recording medium having the attached structure. Thus, there is a demand for a recording medium in which a plurality of recording layers is formed on a substrate surface. In such a recording medium, a recording layer including a plurality of recording films such as a recording film and a dielectric film is formed on a substrate with a signal pattern formed thereon, and a recording layer including a recording film and a dielectric film is formed on the above-mentioned recording layer via a signal pattern formation layer. If required, the signal pattern formation layer and the recording layer are formed repeatedly, and a cover layer to be a light incident surface is formed finally on the recording layer.

It is known that, even in a recording medium including a recording layer formed of a single layer film, and a recording medium such as a ROM including a reflective layer, a recording medium with the similar multi-layer structure can be formed. It is known that, by setting the cover layer side to be a light incident surface for recording, reproducing, and erasing information, the thickness of a light transparent substrate can be made small easily, so the numerical aperture (NA) of a pickup objective lens can be enhanced, which is advantageous in increasing density.

As a method of producing an optical recording medium having a multi-layer structure, there is known a method including the steps of:

(1) forming a signal pattern, and a reflective layer or a recording layer on a support substrate;

(2) coating the reflective layer or the recording layer with an ultraviolet hardening resin, stacking a transparent stamper on the ultraviolet hardening resin, and irradiating the ultraviolet hardening resin with UV-light via the transparent stamper, thereby forming a signal pattern;

(3) peeling the transparent stamper, and forming a reflective layer or a recording layer on the signal pattern formed in the step (2); and

(4) repeating the steps (2) and (3), if required, and forming a cover layer on the reflective layer or the recording layer finally.

It is known that, in the case of the above-mentioned optical recording medium with a multi-layer structure, a problem arises in reproducing, recording, or erasing information by the interference with a signal of each layer unless the interlayer distance between the respective layers is adjusted with high precision. This problem is conspicuous particularly in a case where the NA of the pickup objective lens is increased along with the increase in density, and the control of the order of μm is required.

Regarding the thickness of a coating of the ultraviolet hardening resin layer in the above-mentioned production method, various coating systems such as a spin coat system and a slit coat system is studied to improve uniformity of the thickness. Thus, it is becoming possible to obtain a uniform thickness.

However, regarding the thickness of the ultraviolet hardening resin layer to be finally formed, it is also found that, since a transparent stamper is stacked on unhardened hardening resin, the uniformity of the thickness of the hardening resin layer is degraded influenced by the stacking method, the parallelism of the transparent stamper and the support substrate, and the parallelism between the stamper and the substrate. In particular, in a case of using an injection-molded resin substrate which is excellent in productivity to form a support substrate and a transparent stamper, it is technically difficult to suppress the parallelism within several μm. Therefore, it is difficult to enhance the thickness distribution of the hardening resin layer.

In other words, the thickness of the hardening resin layer in the conventional system can be made uniform at a time of coating, but it is difficult to set the interval between the support substrate and the transparent stamper at a time of stacking to be uniform as a whole. Further, because the hardening resin has flowability, the resin is spread to extend off and to degrade the uniformity of the thickness, with the result that a thickness of the order of μm cannot be controlled.

As the method of improving the thickness of the hardening resin layer, methods described in Japanese Patent Application Laid-Open No. 2003-016702 and Japanese Patent Application Laid-Open No. 2003-331475 are proposed.

Japanese Patent Application Laid-Open No. 2003-016702 discloses a method of coating a support substrate with a hardening resin, coating a transparent stamper with a hardening resin, semi-hardening or completely hardening one hardening resin, stacking the support substrate on the transparent stamper under a condition that another hardening resin is not hardened or semi-hardened, and thereafter completely hardening the hardening resins to obtain a hardening resin layer.

In the case where one hardening resin is not hardened, it is considered that the thickness fluctuation of the hardening resin layer to be formed finally is suppressed by the semi-hardened or hardened thickness of the another hardening resin. However, the thickness fluctuation of the hardening resin that is not hardened cannot be suppressed, so a thickness of the order of μm required for the optical recording medium with a multi-layer structure cannot be controlled sufficiently.

According to the stacking system under the condition of a semi-hardened state and a semi-hardened state or a semi-hardened state and a completely hardened state, the uniformity of a thickness can be enhanced. However, in a case where complete hardening cannot be performed in the later step, there is a failure that, the transparent stamper cannot be peeled well or transferability is degraded. Further, in a case where the semi-hardened state is near to almost completely hardened state, there is a failure that, the hardening resin cannot be attached.

It is known that the hardened state of the hardening resin is fluctuated due to the composition of the resin, the kind and concentration of a photopolymerization initiator, and the wavelength, illumination and irradiation amount of a UV-lamp. It is considered that the hardening reaction of the hardening resin is effected by the polymerization of a radical generated by the decomposition of a photopolymerization initiator mainly due to the irradiation with UV-light. In a case where the concentration of the photopolymerization initiator is small, a semi-hardened state can be formed, but the complete hardening cannot be performed in the later step due to the shortage of the photopolymerization initiator. Further, regarding the anaerobic resin, the termination reaction of radical polymerization due to oxygen is effected, and most of the photopolymerization initiator is decomposed due to the irradiation with UV-light. Therefore, it is considered that, because the surface of the anaerobic resin is unlikely to be hardened completely, a semi-hardened state is obtained easily, but the anaerobic resin cannot be hardened completely in the later step. Further, it is very difficult to control a semi-hardened state, in terms of the stability of the output of a UV-lamp and hardening reaction speed, by adjusting the illuminance and irradiation amount of UV-light.

More specifically, in the above-mentioned conventional example, even if a semi-hardened state is formed, most of the photopolymerization initiator is consumed when a semi-hardened state is obtained, so it is difficult to completely harden the resin. Consequently, a semi-hardened state and a completely hardened state cannot be controlled stably.

Japanese Patent Application Laid-Open No. 2003-331475 discloses an optical disk in which at least two substrates are attached with an ultraviolet hardening resin composition film hardened by thermal cross-linking and UV-light cross-linking.

According to the invention disclosed by Japanese Patent Application Laid-Open No. 2003-331475, a resin composition film having a semi-hardened state is formed by thermal cross-linking, and the resin composition film is irradiated with UV-light after the substrates are attached. It is considered that the uniformity of the thickness occurring in the stacking step can be suppressed by forming a semi-hardened state. However, regarding the thermal cross-linking reaction, a polymerization reaction is slowly performed, so an extremely longer semi-hardening time compared with that of the ultraviolet hardening resin is required. In addition, in a case of forming a thin resin film having a thickness of about 100 μm such as a cover layer, there is a limit to a heating temperature because the heat resistance of a film is inappropriate. Further, while a semi-hardened state is being obtained, it is difficult to keep the thickness of the hardening resin film from being fluctuated. Thus, it is difficult to enhance productivity. Further, thermal cross-linking proceeds even at room temperature. Therefore, there is a limitation of a retention time from a semi-hardened state is formed to the later step, and there is a problem that hardening proceeds to make it impossible to attach the substrates.

In other words, according to the invention described in Japanese Patent Application Laid-Open No. 2003-016702 using only a photopolymerization initiator, it is difficult to control a semi-hardened state and a completely hardened state, and it is difficult to make the thickness of a hardening resin layer uniform. Further, according to the invention described in Japanese Patent Application Laid-Open No. 2003-331475 using a thermal cross-linking agent, although the uniformity of the thickness is enhanced, there is a limitation of a support substrate material, temperature, and the like related to the heat treatment, so it is difficult to enhance productivity. Thus, a high-quality optical recording medium cannot be produced at low cost.

Further, according to the above-mentioned stacking of a substrate and a stamper, it is required to prevent the contamination of air bubbles, which leads to a critical defect such as the tracking shift in recording, reproducing, and erasing. Further, according to the conventional method using a hardening resin having flowability, the thickness is fluctuated by adding a pressure at a time of stacking, so only an extremely limited method can be used for stacking. Further, it is required to perform stacking considering the prevention of the contamination of air bubbles. For example, stacking is performed in vacuum. Thus, it is difficult to enhance the thickness uniformity of hardening resin.

Under the circumstances, there is a demand for an optical recording medium with a multi-layer structure and a method of producing the optical recording medium with a multi-layer structure, capable of forming an adhesive layer or a hardening resin layer in a high-quality optical recording medium with a multi-layer structure at low cost, in which signal pattern transferability of the hardening resin layer is enhanced.

### SUMMARY OF THE INVENTION

In order to enhance a signal pattern transferability of the hardening resin layer capable of forming a hardening resin layer in an optical recording medium with a multi-layer structure with high quality at low cost, the following is provided:

a method of producing an optical recording medium having one of a plurality of recording layers and a plurality of reflective layers, including the steps of:

(1) forming one of a first recording layer and a first reflective layer on a substrate having a first signal pattern surface;

(2) forming a hardening resin layer containing at least two kinds of photopolymerization initiators having different absorbing wavelength ranges on one of the first recording layer and the first reflective layer;

(3) irradiating the hardening resin layer with a first energy line, thereby forming a hardening resin layer in a semi-hardened state;

(4) stacking a stamper on the hardening resin layer in the semi-hardened state;

(5) irradiating the hardening resin layer in the semi-hardened state with a second energy line to harden the hardening resin layer, thereby forming a hardening resin layer having a second signal pattern surface;

(6) forming one of a second recording layer and a second reflective layer on the hardening resin layer having the second signal pattern surface; and

(7) forming a protective layer on one of the second recording layer and the second reflective layer.

Further features of the present invention will become apparent from the following description of exemplary embodiments with reference to the attached drawings.

### BRIEF DESCRIPTION OF THE DRAWINGS

FIGS. 1A, 1B, 1C, 1D, 1E, and 1F are schematic cross-sectional views illustrating a production method of a first exemplary embodiment.

FIGS. 2A, 2B, 2C, and 2D are schematic cross-sectional views illustrating a production method in a second exemplary embodiment.

FIGS. 3A, 3B, 3C, 3D, 3E, 3F, 3G, and 3H are schematic cross-sectional views illustrating a production method in a third exemplary embodiment.

FIGS. 4A, 4B, 4C, 4D, 4E, 4F, 4G, 4H, and 4I are schematic cross-sectional views illustrating a production method in a fourth exemplary embodiment.

### DESCRIPTION OF THE EMBODIMENTS

Hereinafter, the present invention will be described in detail by way of embodiments.

The optical recording medium of the present invention is obtained by irradiating hardening resin with an energy line to form a hardening resin layer with an adhesive layer or a signal pattern surface. The optical recording medium of the present invention is characterized in that the hardening resin layer is formed by using hardening resin containing at least two kinds of photopolymerization initiators having different absorbing wavelength ranges.

In the figures, numerical 1 denotes a first substrate (substrate 1); 2, a reflective layer; 3, a hardening resin layer; 4, a transparent stamper; 5, a reflective layer; 6, a protective layer (organic protective layer); 7, a second substrate (substrate 7); 8, a reflective layer; 9, a hardening resin layer (second hardening resin layer); and 10, a stamper.

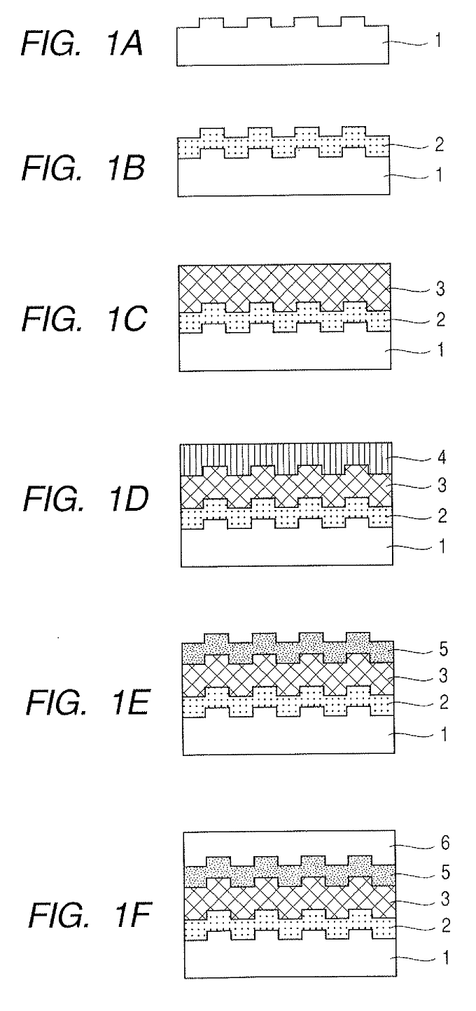

An embodiment of the method of producing an optical recording medium of the present invention illustrated in FIGS. 1A to 1F includes:

(1A) a first step of forming a first substrate (referred to as a substrate 1) having a first signal pattern surface (see FIG. 1A);

(1B) a second step of forming a first recording layer or reflective layer on the first signal pattern surface of the substrate 1 (see FIG. 1B);

(1C) a third step of coating the first recording layer or reflective layer with a first hardening resin containing at least two kinds of photopolymerization initiators having different absorbing wavelength ranges, and irradiating the first hardening resin with a first energy line, thereby forming a first hardening resin layer in a semi-hardened state (see FIG. 1C);

(1D) a fourth step of stacking a transparent stamper on the first hardening resin layer in a semi-hardened state, irradiating the first hardening resin layer with a second energy line via the transparent stamper to harden the first hardening resin layer in a semi-hardened state, thereby forming a first hardening resin layer having a second signal pattern surface (see FIG. 1D);

(1E) a fifth step of forming a second recording layer or reflective layer on the first hardening resin layer having the second signal pattern surface (see FIG. 1E); and

(1F) a sixth step of forming a protective layer on the second recording layer or reflective layer (see FIG. 1F).

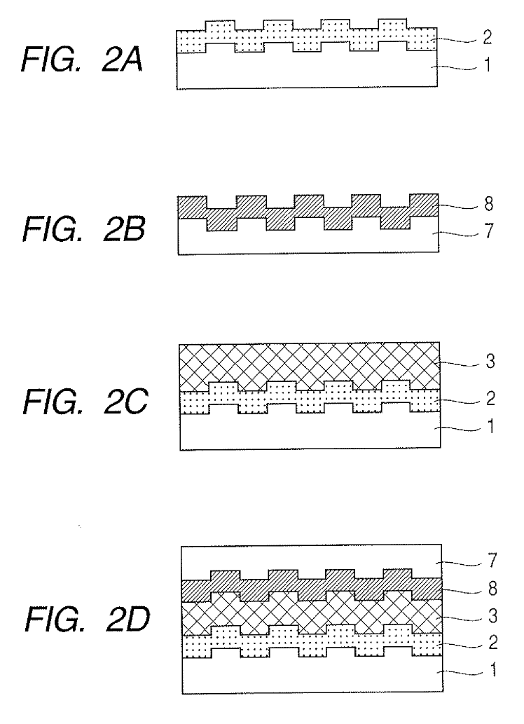

An embodiment of the method of producing an optical recording medium of the present invention illustrated in FIGS. 2A to 2D includes:

(2A) a first step of forming a first substrate (substrate 1) having a first signal pattern surface;

(2B) a second step of forming a first recording layer or reflective layer on the first signal pattern surface of the substrate 1 (see FIG. 2A);

(2C) a third step of forming a second substrate (referred to as a substrate 7) having a second signal pattern surface;

(2D) a fourth step of forming a second recording layer or reflective layer on the second signal pattern surface of the substrate 7 (see FIG. 2B);

(2E) a fifth step of coating at least the recording layer or reflective layer of the substrate 1 or substrate 7 with a first hardening resin containing at least two kinds of photopolymerization initiators having different absorbing wavelength ranges, and irradiating the first hardening resin with a first energy line, thereby forming a first hardening resin layer in a semi-hardened state (see FIG. 2C);

(2F) a sixth step of stacking another substrate on the first hardening resin layer in a semi-hardened state so that a recording layer or reflective layer of the another substrate is opposed to the first hardening resin layer, and irradiating the first hardening resin layer with a second energy line, thereby hardening the first hardening resin in a semi-hardened state (see FIG. 2D); and

(2G) a seventh step of peeling one of the substrates, if required, thereby forming a protective layer on the recording layer or reflective layer.

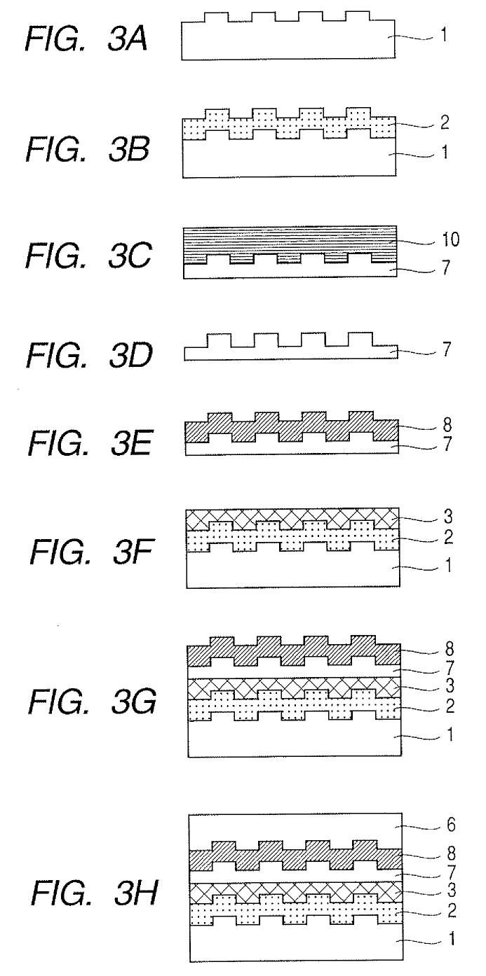

Further, an embodiment of the method of producing an optical recording medium of the present invention illustrated in FIGS. 3A to 3H includes:

(3A) a first step of forming a first substrate (substrate 1) having a first signal pattern surface (see FIG. 3A);

(3B) a second step of forming a first recording layer or reflective layer on the first signal pattern surface of the substrate 1 (see FIG. 3B);

(3C) a third step of forming a second substrate (substrate 7) having a second signal pattern surface (see FIGS. 3C and 3D);

(3D) a fourth step of forming a second recording layer or reflective layer on the second signal pattern surface of the substrate 7 (see FIG. 3E);

(3E) a fifth step of coating at least the recording layer or reflective layer of the substrate 1 or a back surface of the recording layer or reflective layer of the substrate 7 with a first hardening resin containing at least two kinds of photopolymerization initiators having different absorbing wavelength ranges, and irradiating the first hardening resin with a first energy line, thereby forming a first hardening resin layer in a semi-hardened state (see FIG. 3F);

(3F) a sixth step of stacking the substrate 1 and the substrate 7 on the first hardening resin layer in a semi-hardened state so that the recording layer or reflective layer of the substrate 1 is opposed to the surface of the substrate 7 without the recording layer or reflective layer, and irradiating the first hardening resin layer with a second energy line, thereby hardening the first hardening resin in a semi-hardened state (see FIG. 3G); and

(3G) a seventh step of forming a protective layer on the second recording layer or reflective layer (see FIG. 3H).

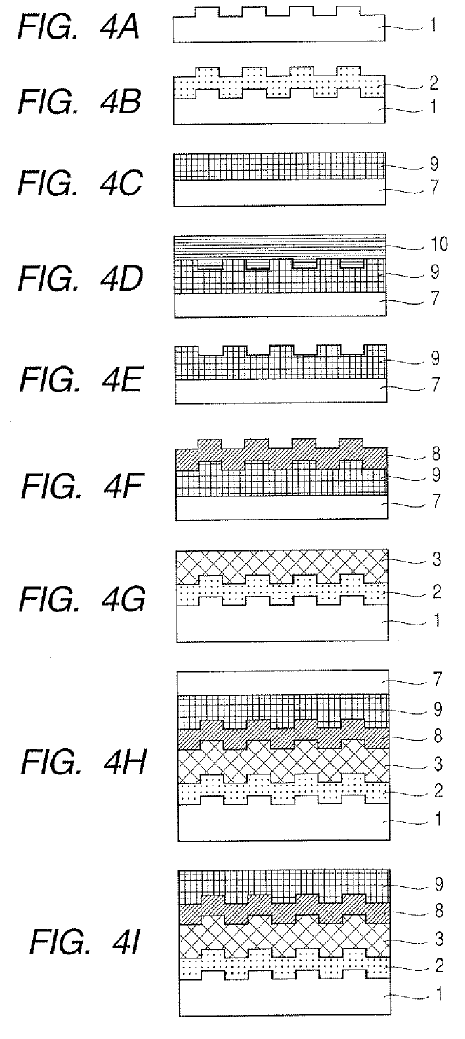

Further, an embodiment of the method of producing an optical recording medium of the present invention illustrated in FIGS. 4A to 4I includes:

(4A) a first step of forming a first substrate (substrate 1) having a first signal pattern surface (see FIG. 4A);

(4B) a second step of forming a first recording layer or reflective layer on the first signal pattern surface of the substrate 1 (see FIG. 4B);

(4C) a third step of forming a second substrate (substrate 7) having a second signal pattern surface, if required;

(4D) a fourth step of coating at least a stamper or the second signal pattern surface or a surface without a signal pattern of the substrate 7 with a second hardening resin containing at least three kinds of photopolymerization initiators having different absorbing wavelength ranges, and irradiating the second hardening resin with a first energy line, thereby forming a second hardening resin layer in a first semi-hardened state (see FIG. 4C);

(4E) a fifth step of stacking the substrate 7 on the second hardening resin layer in a first semi-hardened state formed by coating the stamper with the second hardening resin, stacking a stamper on the second hardening resin layer in a first semi-hardened state formed by coating the second signal pattern surface or the surface without a signal pattern of the substrate 7 with the second hardening resin so that the stamper is opposed to the second hardening resin layer in a first semi-hardened state, and irradiating the stack with a second energy line, thereby forming a second hardening resin layer in a second semi-hardened state (see FIG. 4D);

(4F) a sixth step of peeling the stamper and forming a second recording layer or reflective layer on the signal pattern surface of the second hardening resin layer in a second semi-hardened state (see FIGS. 4E and 4F);

(4G) a seventh step of coating the first recording layer or reflective layer or the second recording layer or reflective layer with a first hardening resin containing at least two kinds of photopolymerization initiators having different absorbing wavelength ranges, and irradiating the first hardening resin with a third energy line, thereby forming a first hardening resin layer in a semi-hardened state (see FIG. 4G);

(4H) an eighth step of stacking the first hardening resin layer in a semi-hardened state and another substrate so that a recording layer or reflective layer of the another substrate is opposed to the first hardening resin layer, and irradiating the stack with a fourth energy line, thereby hardening the first and second hardening resin layers (see FIG. 4H); and

(4I) a ninth step of peeling the substrate 7 (see FIG. 4I).

The substrate (e.g., substrates 1 and 7 illustrated in FIGS. 1A to 4I) used in the present invention and a transparent stamper (e.g., transparent stamper 4 and stamper 10 illustrated in FIGS. 1D, 3C, and 4D) only need to satisfy the wobbling and a wobbling acceleration required in an optical recording medium. It is not necessary to attain the flatness of quality higher than necessity, so the substrates 1 and 7, the transparent stamper 4 and the stamper 10 used in the present invention may be formed by the conventional injection molding and 2P method. The transparent stamper 4 only needs to be permeable to an energy line for complete hardening, and can be formed by using a material such as a polycarbonate resin, an acrylic resin, a polystyrene resin, a silicon resin, a fluorine resin, a polyolefin resin, a Noryl resin, or glass. In order to enhance the peelability of the transparent stamper, it is desirable to use a polyolefin resin, a silicon resin, or a fluorine resin. In the case of curing the hardening resin layer with the two substrates stacked on each other, it is preferable that at least one of the substrates is formed by using a material similar to that of the transparent stamper. The other substrate and the stamper 10 are not limited to the above-mentioned materials, and can be formed by using a material without transparency.

The recording layer or reflective layer (e.g., recording layers or reflective layers 2, 5, and 8 described in FIGS. 1A to 4I) in the present invention is formed on the signal pattern surface by a method such as sputtering. The above-mentioned recording layer or reflective layer can be alternatively formed by, for example, vapor deposition, chemical vapor deposition (CVD), dipping coating, and spin coating. The method of forming the above-mentioned recording or reflective layers is not particularly limited, as long as the method is optimum for each production process, production apparatus, and recording medium to be produced. Examples of an optical recording material that can be used for forming the recording layer include alloys formed of at least one of the materials including Te, In, Ga, Sb, Se, Pb, Ag, Au, As, Co, Ni, Mo, W, Pd, Ti, Bi, Zn, and Si. Those materials are widely known in general, and a number of materials have already been used in the known techniques. In addition, the examples further include alloys formed of at least one of the materials including Tb, Fe, Co, Cr, Gd, Dy, Nd, Sm, Ce, and Ho that are magnetooptical recording materials, and rare earth-transition metal alloys. A number of those materials have already been used widely in the known techniques. Further, cyanin-based, phthalocyanin-based, and azo-based organic colorant materials can be used for forming a recording layer.

Examples of a material that can be used for forming the reflective layer include Al, an Al alloy, Si, SiN, Ag, and an Ag alloy. These materials are also used widely and have already been used in the known techniques.

The thickness of each of the above-mentioned recording layer or reflective layer can be set arbitrarily. However, light is attenuated in each recording layer and reflective layer from a light incident surface side, so it is desirable to set the thickness so as to increase the transmittance in a light wavelength to be used toward the incident surface side. It is preferable to form a structure in which there is no problem in recording, reproducing, and erasing in each layer by adjusting the composition and thickness of each recording layer and reflective layer.

By optimizing the composition, thickness or layer formation condition for each hardening resin layer or substrate, a recording layer and a reflective layer with an arbitrary transmittance and reflectivity can be formed. In the present invention, there is no particular limitation to the use of a material for forming a recording layer and a reflective layer suitable for an optical recording medium to be required.

In the present invention, by forming a hardening resin layer, a recording layer, and a reflective layer repeatedly, an optical recording medium with a predetermined multi-layer structure can be formed. In the case of a multi-layer structure, the following methods can be used. That is: a method of stacking a hardening resin layer, and a recording layer or a reflective layer on a substrate; and a method of stacking a plurality of thin substrates, a recording layer or a reflective layer, and a hardening resin layer on a substrate. Further, a method of stacking substrates having a plurality of recording layers or reflective layers and a hardening resin layer, respectively, to each other can also be used.

Next, the recording layer or reflective layer of the first substrate in the production method illustrated in FIGS. 1A to 1F, the recording layer or reflective layer of the first or second substrate in the production method illustrated in FIGS. 2A to 2D, the recording layer or reflective layer of the first substrate, or the recording layer or reflective layer of the second substrate or a surface opposite thereto in the production method illustrated in FIGS. 3A to 3H is coated with first hardening resin containing at least two kinds of photopolymerization initiators having different absorbing wavelength ranges, and irradiating the first hardening resin with a first energy line, thereby forming a first hardening resin layer in a semi-hardened state. Further, in the production method illustrated in FIGS. 4A to 4I, the recording layer or reflective layer of the first substrate or the second recording layer or the reflective layer formed on the second hardening resin layer is coated with first hardening resin containing at least two kinds of photopolymerization initiators having different absorbing wavelength ranges, and irradiating the first hardening resin with a third energy line, thereby forming a first hardening resin layer in a semi-hardened state.

As the first hardening resin or second hardening resin used in the present invention, any resin can be used as long as the resin reacts with a photopolymerization initiator to effect a polymerization reaction when irradiated with an energy line. A polymerizable resin material such as epoxy acrylate, urethane acrylate, polyester acrylate, polyether acrylate, polybutadiene acrylate, and silicon acrylate, and a material containing an additive such as a reactive diluent can be used. In the same way as in a photopolymerization initiator described later, it is desirable to use a resin having less absorption in a light wavelength range of recording, reproducing, and erasing.

The first hardening resin in the present invention only needs to contain at least two kinds of photopolymerization initiators having different absorbing wavelength ranges. The combination of the above-mentioned two kinds of photopolymerization initiators is not limited to a combination of photopolymerization initiators having respective absorbing wavelength ranges in a UV-light range and a visible light range, and may be a combination of photopolymerization initiators having absorbing wavelength ranges in UV-light ranges with a short wavelength and a long wavelength. Further, the second hardening resin may contain at least three kinds of photopolymerization initiators having different absorbing wavelength ranges. A combination of at least three kinds of photopolymerization initiators may include a combination of, for example, the following three kinds including a UV-light range of a short wavelength range, a UV-light range of a long wavelength range, and a visible light range.

As the photopolymerization initiator that can be used in the present invention, a general radical polymerization initiator and cation polymerization initiator can be used. However, a material with less absorption in a light wavelength range of recording, reproducing, and erasing is desirable. Specifically, there are acetophenone-based, benzoin-based, benzophenone-based, thioxanthene-based, dicarbonyl-based, and acylphosphineoxide-based photopolymerization initiators. Specific examples thereof include 1-hydroxy-cyclohexyl-phenylketone, 2-hydroxy-2-2-methyl-1-phenyl-propane-1-one, 2,2-dimethoxy-1,2-diphenylethane-1-one, 2-methyl-1-(4-methylthiophenyl)-2-morpholinopropane-1-one.

Further, regarding the first hardening resin, the concentration of the photopolymerization initiator is preferably set to be 0.01 to 10% by mass. When the concentration of the photopolymerization initiator is set to be 0.01% by mass or more, a polymerization reaction can proceed sufficiently. Further, when the concentration of the photopolymerization initiator is set to be 10% by mass or less, the first hardening resin is prevented from being hardened excessively and the photopolymerization initiator is prevented from remaining, whereby the adverse effect such as corrosion of the reflective layer or recording layer can be prevented. When the concentration of the photopolymerization initiator is set to be 0.01% by mass or more, the first hardening resin can be hardened sufficiently even with a light source of a low or high output. Further, the photopolymerization initiator to be used may have a large absorbing wavelength range and influence the light wavelength range of recording, reproducing, and erasing. Therefore, the concentration of the photopolymerization initiator is more preferably 0.1 to 5% by mass. In the case where the first hardening resin contains two kinds of photopolymerization initiators having different absorbing wavelength ranges, it is preferable to set the ratio (mass ratio) in a compounded amount of the photopolymerization initiator having an absorbing wavelength range of 200 to 400 nm to the photopolymerization initiator having an absorbing wavelength range of 400 to 600 nm is set to be 1/10 to 10/1.

Further, regarding the second hardening resin, the concentration of the photopolymerization initiator is preferably set to be 0.015 to 10% by mass. When the concentration of the photopolymerization initiator is 0.015% by mass or more, the hardened state can be controlled. Further, when the photopolymerization initiator is set to be 10% by mass or less, the inhibition of a polymerization reaction due to the excessive addition of a photopolymerization initiator can be prevented. Further, in the same way as in the first hardening resin, the amount of the photopolymerization initiator and a decomposed component remaining after the polymerization reaction can be reduced, whereby odor and an adverse effect on a human body can be prevented. In the case where the second hardening resin contains three kinds of photopolymerization initiators having different absorbing wavelength ranges, it is preferable that the compounded amounts of the photopolymerization initiator having an absorbing wavelength range of 200 to 300 nm, the photopolymerization initiator having an absorbing wavelength range of 300 to 400 nm, and the photopolymerization initiator having an absorbing wavelength range of 400 to 600 nm is preferably set to be 10 to 80% by mass, 10 to 80% by mass, and 10 to 80% by mass, respectively, with respect to the total mass of the photopolymerization initiators.

The method of preparing the first hardening resin and the second hardening resin is not particularly limited. The first hardening resin and second hardening resin may be prepared by a known preparation method, for example, a method of simultaneously mixing a polymerizable resin called an oligomer, a reactive diluent, a photopolymerization initiator, and an additive, and a method of mixing a polymerization resin, a reactive diluent, and a photopolymerization initiator in stages.

Further, the first hardening resin or second hardening resin may be applied by a coating method capable of setting the thickness distribution in which the thickness of a hardening resin layer to be finally formed is within an allowable value, and spin coating, slit coating, slit and spin coating, roll coating or screen printing can be used. Particularly, in the case of coating a substrate having a center hole with the first or second hardening resin, it is preferable to perform a method of enhancing a thickness such as spin coating of closing a center hole so as to enhance the uniformity of a thickness.

In the production methods illustrated in FIGS. 1A to 3H, the first hardening resin layer is irradiated with a first energy line, whereby a first hardening resin layer in a semi-hardened state is formed (the third process of the production method of FIG. 1C and the fifth process of each of the production method of FIGS. 2E and 3E).

Specifically, for example, 2% by mass of photopolymerization initiator, benzoin-based benzoinmethylether having an absorbing range in a UV-light range and 0.5% by mass of a photopolymerization initiator, dicarbonyl-based camphorquinone having an absorbing range in a long wavelength range of 400 nm or more are contained in the first hardening resin layer. The first hardening resin layer at 5° C. to 95° C. is irradiated with visible light in a wavelength range of 400 nm or more as the above-mentioned first energy line in the air, whereby a first hardening resin layer in a semi-hardened state is formed. In the irradiation of visible light in a wavelength range of 400 nm or more, for example, a halogen lamp, a light-emitting diode, or a mercury lamp with a UV-light range cut can be used. In this case, the radiation amount is preferably set to be 200 mJ/cm² to 2000 mJ/cm².

The first hardening resin layer in a semi-hardened state may be hardened to such an extent that the flowability thereof can be controlled. The extent of hardening may be adjusted in accordance with the composition and production method of the first hardening resin, and the first hardening resin may be generally hardened to such an extent that a gel fraction is 30 to 95%. Preferably, if the first hardening resin is set to be in a semi-hardened state in which a gel fraction is 50 to 90%, the flowability thereof can be controlled easily, and trouble in terms of production due to the shortage of hardening and complete hardening can be reduced. In the present invention, the percentage of a Soxhlet extracted residual with respect to the mass of a sample to be tested, which is used for Soxhlet extraction, is set to be a gel fraction.

Then, the first hardening resin layer in a semi-hardened state is completely hardened by irradiating UV-light in a wavelength range of 400 nm or less.

Specifically, for example, a transparent stamper or a recording layer or a reflective layer of another substrate is stacked on the first hardening resin layer in a semi-hardened state. Alternatively, the another substrate is stacked on the first hardening resin layer such that a surface thereof having no recording layer and reflective layer faces the first hardening resin layer. Then, the stack is irradiated with a second energy line, whereby a completely hardened hardening resin layer is formed. At this time, UV-light having a wavelength range of 400 nm or less is radiated as the second energy line at 5° C. to 95° C. in the air. In the irradiation of UV-light having a wavelength range of 400 nm or less, for example, a high-pressure mercury lamp or a metal halide lamp can be used. In this case, the radiation amount is preferably set to be 200 mJ/cm² to 2000 mJ/cm². The gel fraction of the completely hardened first hardening resin layer is preferably 30 to 95%. In this case, the semi-hardened state can be controlled easily, and trouble in terms of production due to insufficient hardening and excess hardening in an intermediate stage can be controlled.

The third or fifth process may be performed as follows. That is, a resin sheet is previously coated with a first hardening resin containing at least two kinds of photopolymerization initiators having different absorbing wavelength ranges, and the first hardening resin is irradiated with a first energy line, whereby a first hardening resin layer in a semi-hardened state is formed. Next, the first recording layer or reflective layer of the first substrate is stacked on the first hardening resin layer in a semi-hardened state, and the resin sheet is peeled. Then, a first hardening resin layer in a semi-hardened state is formed on the surface of the first recording layer or reflective layer of the first substrate.

A resin sheet is previously coated with first hardening resin containing at least two kinds of photopolymerization initiators having different absorbing wavelength ranges, and the first hardening resin is irradiated with a first energy line, whereby a first hardening resin layer in a semi-hardened state is formed. Next, the first recording layer or reflective layer of the first substrate, or the second recording layer or reflective layer of the second substrate is stacked on the first hardening resin layer in a semi-hardened state. Alternatively, the second substrate is stacked on the first hardening resin layer such that a surface thereof having no second recording layer and reflective layer faces the first hardening resin layer. Then, the resin sheet is peeled. Then, a first hardening resin layer in a semi-hardened state is formed on the surface of the first recording layer or reflective layer of the first substrate, the surface of the second recording layer or reflective layer of the second substrate, or the surface thereof having no second recording layer and reflective layer.

In the production method illustrated in FIGS. 4A to 4I, a stamper, a second signal pattern surface of a substrate, or a surface thereof having no signal pattern is coated with the second hardening resin layer, and the second hardening resin layer is irradiated with a first energy line, whereby a second hardening resin layer in a first semi-hardened state is formed. In the case where the second hardening resin layer in a first semi-hardened state is formed on the signal pattern surface of the stamper, the substrate 7 is stacked such that a signal pattern surface faces the second hardening resin layer, followed by irradiation with a second energy line, whereby a second hardening resin layer in a second semi-hardened state is formed. Further, in the case where the second hardening resin layer in a first hardened state is formed on the second signal pattern surface of the substrate 7 or a surface thereof having no signal pattern, the stamper is stacked such that the signal pattern surface faces the second hardening resin layer, followed by irradiation with the second energy line, whereby a second hardening resin layer in a second semi-hardened state is formed. Next, the stamper is peeled, and a second recording layer or reflective layer is formed on the signal pattern surface of the second hardening resin layer in a second semi-hardened state.

Specifically, for example, at least 0.5% by mass of camphorquinone having an absorbing range in a wavelength range of 400 to 600 nm, 0.5% by mass of a photopolymerization initiator, benzoinisopropylether having an absorbing range in a wavelength range of 300 to 400 nm, and 2.0% by mass of a photopolymerization initiator, benzoinmethylether having an absorbing range in a wavelength range of 200 to 300 nm are contained in the second hardening resin layer. The second hardening resin layer is irradiated with light in a wavelength range of 400 to 600 nm as the first energy line at 5° C. to 95° C. in the air, whereby a second hardening resin layer in a first semi-hardened state is formed. In the irradiation of light in a wavelength range of 400 to 600 nm, for example, a halogen lamp or a light-emitting diode can be used. In this case, the radiation amount is preferably set to be 200 mJ/cm² to 2000 mJ/cm².

The second hardening resin layer in a first semi-hardened state may be hardened to such an extent that the flowability thereof can be limited. The extent of hardening may be adjusted depending upon the composition and production method of the second hardening resin, and the second hardening resin is generally hardened to such an extent that a gel fraction is 10 to 95%. Preferably, if the second hardening resin is set to be in the first semi-hardened state in which a gel fraction is 50 to 90%, the second hardening resin can be controlled easily, and trouble in terms of production due to insufficient hardening and complete hardening can be reduced.

Then, the second hardening resin layer in a first semi-hardened state is irradiated with light having a wavelength range of 300 to 400 nm as the second energy line at 5° C. to 95° C. in the air, whereby a second hardening resin layer in a second semi-hardened state is formed. In the irradiation of light having a wavelength range of 300 to 400 nm, for example, a high-pressure mercury lamp or a metal halide lamp can be used. In this case, it is preferable that the radiation amount is set to be 200 mJ/cm² to 2000 mJ/cm².

The second hardening resin layer in a second semi-hardened state may be hardened, for example, to such an extent that a recording layer or a reflective layer can be formed stably. The extent of hardening may be adjusted in accordance with the composition and production method of the hardening resin, and generally, the second hardening resin may be hardened to such an extent that a gel fraction is 70 to 98%. Preferably, if the second hardening resin layer in a second semi-hardened state is formed in which a gel fraction is 90 to 97%, the hardened state can be controlled easily, whereby the productivity can be enhanced.

Next, the first hardening resin layer applied to the first recording layer or reflective layer, or the second recording layer or reflective layer is irradiated with a third energy line, whereby a semi-hardening first hardening resin layer is formed. The first hardening resin may be hardened in the same way as in the formation of the semi-hardening first hardening resin layer in the production methods illustrated in FIGS. 1A to 3H.

Further, the semi-hardening first hardening resin layer may be formed as follows. That is, a resin sheet is previously coated with a first hardening resin containing at least two kinds of photopolymerization initiators having different absorbing wavelength ranges, and the first hardening resin is irradiated with a third energy line, whereby a first hardening resin layer in a semi-hardened state is formed. Next, the first recording layer or reflective layer of the first substrate or the second recording layer or reflective layer of the second substrate is stacked on the first hardening resin layer in a semi-hardened state. Then, the resin sheet is peeled, and a first hardening resin layer in a semi-hardened state is formed on the surface of the first recording layer or reflective layer of the first substrate, or the second recording layer or reflective layer of the second substrate.

Then, the above-mentioned semi-hardening first hardening resin layer is stacked on a recording layer or reflective layer of another substrate, followed by irradiation with a fourth energy line, whereby the first hardening resin layer in a semi-hardened state and the second hardening resin layer in a second semi-hardened state are hardened completely. In this case, light having a wavelength range of 200 to 300 nm is radiated as the fourth energy line at 5° C. to 95° C. in the air. In the irradiation of light in a wavelength range of 200 to 300 nm, for example, a high-pressure mercury lamp or a metal halide lamp can be used. It is preferable that the radiation amount is 200 mJ/cm² to 2000 mJ/cm². The gel fraction of the completely hardened second hardening resin layer is preferably 95 to 100%, whereby the hardness and strength required in the hardening resin layer can be obtained.

As described above, in the optical recording medium having a multi-layer structure in the present invention, in order to enhance the uniformity of thickness of the hardening resin layer having an adhesive layer or a signal pattern surface, the hardening resin layer is formed in a semi-hardened state. In the semi-hardened state, unlike the unhardened state, the flowability of the hardening resin constituting the hardening resin layer is limited, so the uniform thickness during coating can be retained. Consequently, a completely hardened hardening resin layer having a uniform thickness can be formed without being influenced by the flatness and parallelism of a substrate and a transparent stamper, and a stacking method.

Further, in the present invention, by setting the hardening resin layer in a semi-hardened state, the flowability of the hardening resin constituting the hardening resin layer is limited. Therefore, even if a method of applying a pressure, such as spreading with a roll, during stacking of a substrate and a stamper, the thickness of the layer is not fluctuated. Thus, various stacking methods, which are difficult in a conventional system with flowability, can be used.

Further, in the present invention, at least two kinds (at least three kinds in the production method illustrated in FIGS. 4A to 4I) of photopolymerization initiators having different absorbing wavelength ranges are contained. Then, when a hardening resin layer in a semi-hardened state is formed by a photopolymerization initiator that reacts with the first energy line (the first, second, or third energy line in the production method illustrated in FIGS. 4A to 4I), a photopolymerization initiator that is not reacted remains. Then, a second energy line (the fourth energy line in the production method illustrated in FIGS. 4A to 4I) is radiated, to allow the remaining photopolymerization initiator to react, which enables complete hardening.

A photopolymerization initiator used in a conventional general ultraviolet hardening resin generally has an absorbing range in a wavelength range of 200 to 400 nm, and hardens resin by irradiating an energy line in the above-mentioned wavelength range with an ultraviolet lamp such as a high-pressure mercury lamp or a metal halide lamp. However, in the present invention, the hardening resin contains a photopolymerization initiator having an absorbing range in a UV-light range and a photopolymerization initiator having an absorbing range in a wavelength range of 400 nm or more. A semi-hardened state is realized by irradiating the hardening resin layer with visible light having a wavelength range of 400 nm or more, and complete hardening is realized by irradiating the hardening resin layer with UV-light in a wavelength range of 400 nm or less. By selecting the composition of the hardening resin, and the kind and concentration of the photopolymerization initiator, even if visible light is radiated excessively, a hardening resin layer in a semi-hardened state, which is not hardened completely, can be formed easily. Further, the photopolymerization initiator having an absorbing range in a UV-light range does not react in a visible light range. Therefore, the photopolymerization initiator does not start a polymerization reaction until the irradiation of UV-light, which realizes complete hardening easily.

Further, the production method of the present invention is different from the method of controlling a semi-hardened state and a completely hardened state with a photopolymerization initiator as in the prior art. In the production method of the present invention, at least two kinds (at least three kinds in the production method illustrated in FIGS. 4A to 4I) of polymerization initiators are used to react with an energy line in a particular wavelength range, whereby a polymerization reaction is effected without being influenced by the change in intensity of a UV-lamp. Consequently, a semi-hardened state can be formed stably, and a completely hardened state can also be realized easily.

Further, unlike a conventional thermal cross-linking system, according to the production method of the present invention, a hardened state can be realized within a short period of time, and an ordinary halogen lamp or the like can be used for a photopolymerization initiator that reacts with visible light, whereby an apparatus can be simplified.

Further, the protective layer to be formed on the recording layer or the reflective layer can be formed by stacking a resin sheet with an adhesive or applying hardening resin, followed by hardening. If required, a plurality of hardening resin layers can also be formed.

An adhesive layer can enhance the adhesion with respect to an adherend by combining, if required, various systems including the chemical adhesion such as chemical bonding, the physical adhesion such as Van der Waals' force, and the adhesion due to cohesion. If required, an additive and processing can be used so as to enhance the adhesion.

Specifically, most of the hardening resin that reacts with the photopolymerization initiator has a high adhesion with polycarbonate resin or acrylic resin, and can function as an adhesive layer with sufficiently high adhesion by completely hardening the hardening resin under the condition that the adhesive layer in a semi-hardened state is in contact with an adherend such as polycarbonate resin or acrylic resin. Further, by subjecting the surface of an adherend to UV ozone treatment or plasma treatment, the cleanness of the surface can be enhanced, and the adhesion can also be enhanced by refining the surface state. In the case where the adherend is glass or metal, silane coupling agent treatment or primer treatment can also be performed. The above-mentioned treatments include a method of forming a thin film layer on an adherend. However, the thin film layer does not influence the thickness distribution of the hardening resin layer because the thickness of the thin film layer is extremely small.

Hereinafter, the present invention will be described further by way of examples.

### EXAMPLE 1

FIGS. 1A to 1F illustrate a method of producing an optical recording medium in this example.

A polycarbonate resin substrate (referred to as substrate 1) (thickness: 1.1 mm, outer diameter: 80 mm, inner diameter: 15 mm) having a signal pattern on one surface was formed by injection molding (see FIG. 1A). Next, a reflective layer 2 was formed by a sputtering film formation apparatus on the surface of the substrate 1 where the signal pattern was formed (see FIG. 1B). The reflective layer 2 was formed of an Ag alloy, and the thickness thereof was 10 nm.

Next, the reflective layer 2 was coated with a first hardening resin (thickness: 25 μm) containing 0.5% by mass of a first photopolymerization initiator including epoxyacrylate and dicarbonyl-based camphorquinone and 2% by mass of a second photopolymerization initiator including benzoin-based benzoinmethylether, whereby a first hardening resin layer 3 was formed (see FIG. 1C). In order to improve the thickness distribution in a radial direction, the first hardening resin was applied by spin coating which seals a center hole with a cap. The first photopolymerization initiator reacts with visible light and has an absorbing range in a wavelength range of 450 nm or more at the above-mentioned concentration, and the second photopolymerization initiator reacts with UV-light and has an absorbing range in a wavelength range of 240 to 300 nm at the above-mentioned concentration. Then, the first hardening resin layer 3 was irradiated with visible light using a halogen lamp, whereby the first hardening resin layer 3 was semi-hardened. Accordingly, the first hardening resin layer 3 in a semi-hardened state, which is uniform over the entire surface and has a thickness of 25±1 μm, was formed.

On the first hardening resin layer 3 in a semi-hardened state, a transparent stamper 4 formed by injection molding was stacked in vacuum with the signal pattern surface of the transparent stamper 4 opposed to the first hardening resin layer 3, in the same way as in the substrate 1 (see FIG. 1D). UV-light was radiated from the transparent stamper 4 side to completely harden the first hardening resin layer 3, and the transparent stamper 4 was peeled off, whereby a signal pattern was formed on the first hardening resin layer 3. The thickness of the first hardening resin layer 3 with the signal pattern formed thereon was 25±1 μm, and the thickness was not fluctuated by the stacking and hardening processes.

Next, an SiN layer was formed in a thickness of 10 nm by sputtering on the signal pattern surface of the first hardening resin layer 3 with the signal pattern formed thereon, whereby a reflective layer 5 was formed (see FIG. 1E). Further, an organic protective layer 6 formed of a polycarbonate resin sheet having an adhesive layer was stacked on the reflective layer 5, whereby an optical recording medium was produced. The thickness of the organic protective layer was 75 μm. The optical recording medium was produced easily, with excellent thickness uniformity and without defects such as the contamination of air bubbles in the first hardening resin layer or the spreading of the resin.

Further, the optical recording medium was reproduced with laser light of 405 nm, whereby signal characteristics of high quality with a jitter of 4 to 6% and a signal noise of −70 to −80 dB were obtained. It is considered from the result that a signal pattern was transferred satisfactorily in the above-mentioned optical recording medium.

### EXAMPLE 2

FIGS. 2A to 2D illustrate a method of producing an optical recording medium in this example.

As a first substrate, a polycarbonate resin substrate (referred to as substrate) (thickness: 1.1 mm, outer diameter: 80 mm, inner diameter: 15 mm) having a signal pattern on one surface was formed by injection molding. Next, a reflective layer 2 was formed by a sputtering film formation apparatus on the surface of the substrate 1 where the signal pattern was formed (see FIG. 2A). The reflective layer 2 was formed of an Ag alloy, and the thickness thereof was 10 nm.

A stamper was stacked on a thermoplastic resin sheet formed of a polycarbonate resin (thickness: 75 μm), followed by pressing and heating, whereby a second substrate (referred to as substrate 7) having a signal pattern was formed. An SiN layer (thickness: 10 nm) was formed by sputtering on the surface of the substrate 7 where the signal pattern was formed, whereby a reflective layer 8 was formed (see FIG. 2B).

The reflective layer 2 of the substrate 1 was coated with a first hardening resin (thickness: 25 μm) in the same way as in Example 1, whereby a first hardening resin layer 3 was formed (see FIG. 2C). Then, the first hardening resin layer 3 was irradiated with visible light using a halogen lamp, whereby the first hardening rein layer 3 was semi-hardened. After that, the reflective layer 8 of the substrate 7 and the first hardening resin layer 3 were stacked on each other. Then, UV-light was radiated from the substrate 7 side to completely harden the first hardening resin layer 3, whereby an optical recording medium was produced (see FIG. 2D). The thickness of the completely hardened first hardening resin layer 3 was 25±1 μm.

In this example, although the transmission amount of UV-light was attenuated by the reflective layer 8, there was no problem in hardening the first hardening resin layer 3. Further, the optical recording medium was reproduced with laser light of 405 nm, whereby signal characteristics of high quality with a jitter of 4 to 6% and a signal noise of −70 to −80 dB were obtained. It is considered from the result that a signal pattern was transferred satisfactorily in the above-mentioned optical recording medium.

In the optical recording medium produced in this example, the substrate 7 functions as the organic protective layer. Therefore, it is not necessary to form an organic protective layer on the reflective layer 8, whereby the productivity was enhanced with processes simplified. Further, the substrates on which the reflective layers 2 and 8 are formed are different. Therefore, the same substrate does not need to be input repeatedly in a film formation process, and consequently, an optical recording medium of high quality can be produced with enhanced productivity and without being influenced by heat during film formation of the reflective layer.

In this example, an optical recording medium is produced by attaching the first hardening resin layer 3 through hardening. However, if desired, the substrate 7 may be peeled off, and the hardening resin layer and the reflective layer may be formed repeatedly, or the organic protective layer may be formed on the reflective layer.

### EXAMPLE 3

FIGS. 3A to 3H illustrate a method of producing an optical recording medium in this example.

A polycarbonate resin substrate (referred to as substrate 1) (thickness: 1.1 mm, outer diameter: 80 mm, inner diameter: 15 mm) having a signal pattern on one surface was formed by injection molding (see FIG. 3A).

Next, a reflective layer 2 was formed by a sputtering film formation apparatus on the surface of the substrate 1 where the signal pattern was formed (see FIG. 3B). The reflective layer 2 was formed of an Ag alloy, and the thickness thereof was 10 nm.

As a second substrate, a stamper 10 was stacked on a thermoplastic resin sheet formed of a polycarbonate resin (thickness: 20 μm), followed by pressing and heating (see FIG. 3C), whereby a substrate having a signal pattern was formed (see FIG. 3D). An SiN layer (thickness: 10 nm) was formed by sputtering on the surface of the substrate 7 where the signal pattern was formed, whereby a reflective layer 8 was formed (see FIG. 3E).

The reflective layer 2 of the substrate 1 was coated with a first hardening resin (thickness: 5 μm) in the same way as in Example 1, whereby a first hardening resin layer 3 was formed (see FIG. 3F). The first hardening resin layer 3 was irradiated with visible light to be semi-hardened. After that, a surface of the substrate 7 where the reflective layer 8 is not formed was stacked on the first hardening resin layer 3 (see FIG. 3G). Then, UV-light was radiated from the substrate 7 side to completely harden the first hardening resin layer 3, and an organic protective layer 6 formed of a polycarbonate resin sheet having an adhesive layer was stacked on the reflective layer 8, whereby an optical recording medium was produced (see FIG. 3H). The organic protective layer had a thickness of 75 μm, and the thickness of the completely hardened first hardening resin layer 3 and the organic protective layer 6 was 25±2 μm.

Although the thickness uniformity decreased slightly due to the fluctuation of each thickness of the first hardening resin layer 3 and the organic protective layer 6, there was no problem in recording, reproducing, and erasing. Further, the optical recording medium was reproduced with laser light of 405 nm, whereby signal characteristics of high quality with a jitter of 4 to 6% and a signal noise of −70 to −80 dB were obtained. It is considered from the result that a signal pattern was transferred satisfactorily in the above-mentioned optical recording medium.

In this example, the substrate 7 having the reflective layer 8 was attached with a highly precise thickness. Further, if desired, a plurality of the substrates 7 having a recording layer can be attached repeatedly to simplify a method of producing an optical recording medium with a multi-layer structure.

### EXAMPLE 4

FIGS. 4A to 4I illustrate a method of producing an optical recording medium in this example.

As a first substrate, a polycarbonate resin substrate (referred to as substrate 1) (thickness: 1.1 mm, outer diameter: 80 mm, inner diameter: 15 mm) having a signal pattern on one surface was formed by injection molding (see FIG. 4A). Next, a reflective layer 2 was formed by a sputtering film formation apparatus on the surface of the substrate 1 where the signal pattern was formed (see FIG. 4B). The reflective layer 2 was formed of an Ag alloy, and the thickness thereof was 10 nm.

A glass substrate 7 (thickness: 1.1 mm) without a signal pattern was prepared. The glass substrate 7 was coated with a hardening resin (thickness: 75 μm) containing, as a second hardening resin 9, 0.5% of first photopolymerization initiator including urethaneacrylate and dicarbonyl-based camphorquinone, 0.5% of second photopolymerization initiator including benzoin-based benzoinisopropylether, and 2.0% of third photopolymerization initiator including benzoin-based benzoinmethylether, whereby a second hardening resin layer 9 was formed (see FIG. 4C). The first photopolymerization initiator reacts with visible light and has an absorbing range in a wavelength range of 450 nm or more at the above-mentioned concentration. The second photopolymerization initiator reacts with UV-light and has an absorbing range in a wavelength range of 350 to 360 nm at the above-mentioned concentration. Further, the third photopolymerization initiator reacts with UV-light and has an absorbing range in a wavelength range of 240 to 300 nm at the above-mentioned concentration. Then, the second hardening resin layer 9 was irradiated with visible light using a halogen lamp, whereby the second hardening resin layer 9 was set to a first semi-hardened state without flowability, and a stamper 10 and the second hardening resin layer 9 were stacked (see FIG. 4D).

Then, the second hardening resin layer 9 was irradiated with UV-light via a filter transmitting only light of a wavelength range of 350 to 360 nm, whereby the second hardening resin layer 9 was set to a second semi-hardened state. In addition, the stamper 10 was peeled off, whereby a signal pattern was formed on the second hardening resin layer 9 on the glass substrate 7 (see FIG. 4E).

Next, an SiN layer was stacked in a thickness of 10 nm by sputtering on the signal pattern surface of the second hardening resin layer 9 with the signal pattern formed thereon, whereby a reflective layer 8 was formed (see FIG. 4F).

Further, the reflective layer 2 of the substrate 1 was coated with the first hardening resin in the same way as in Example 1, whereby a first hardening resin layer 3 was formed (see FIG. 4G). Then, the first hardening resin layer 3 was irradiated with visible light using a halogen lamp, whereby the first hardening resin layer 3 was semi-hardened. After that, the reflective layer 8 on the glass substrate 7 and the first hardening resin layer 3 were arranged to oppose each other and stacked (see FIG. 4H). Then, UV-light was radiated from the glass substrate 7 side, whereby the second hardening resin layer 9 and the first hardening resin layer 3 were completely hardened. Further, the glass substrate 7 was peeled off to form an organic protective layer formed of the second hardening resin layer 9, whereby an optical recording medium was produced (see FIG. 4I). The thickness of the completely hardened first hardening resin layer 3 was 25±1 μm, and the thickness of the second hardening resin layer 9 was 75±1 μm. Further, a gel fraction was measured by subjecting the second hardening resin 9 to a Soxhlet extraction method using acetone. Consequently, the gel fraction in the first semi-hardened state of the second hardening resin layer 9 was 60%, the gel fraction in the second semi-hardened state was 95%, and the gel fraction of the completely hardened second hardening resin layer 9 was 99.5%.

By allowing the second hardening resin for forming the second hardening resin layer 9 to contain three kinds of photopolymerization initiators, the first semi-hardened state without flowability, the second semi-hardened state in which a signal pattern can be formed and which has adhesiveness because of incomplete hardening, and a completely hardened state can be controlled easily. This enables the peeling property between the glass substrate 7 and the second hardening resin layer 9 to be controlled, and if desired, the second hardening resin layer 9 can be made difficult to be peeled off from the glass substrate 7 or can be made easy to be peeled off in a later process. Further, a hardening resin layer with a uniform thickness can be formed on a substrate. More specifically, by allowing the substrate to hold the hardening resin layer with a small thickness, the problems such as difficulty in layer formation and transportation in dealing with sheet resins can be solved, and by controlling the hardened state of the hardening resin layer step-wise, the substrate can be peeled off in an arbitrary process. Further, this enables the productivity of the optical recording medium with a multi-layer structure to be enhanced. Regarding the second hardening resin layer 9 on the glass substrate 7, signal patterns can be formed on both surfaces by forming a signal pattern on the glass substrate 7, whereby the productivity can be enhanced in production of an optical recording medium with a multi-layer structure of three layers or more.

Further, the optical recording medium was reproduced with laser light of 405 nm, whereby signal characteristics of high quality with a jitter of 4 to 6% and a signal noise of −70 to −80 dB were obtained. It is considered from the result that a signal pattern was transferred satisfactorily in the above-mentioned optical recording medium.

### EXAMPLES 5 TO 8

A polyethyleneterephthalate film (thickness: 100 μm) containing a release agent was coated with a hardening resin by slit coating to form a first hardening resin layer 3. Then, the first hardening resin layer 3 was irradiated with visible light using a halogen lamp, whereby a first hardening resin layer 3 was semi-hardened.

An optical recording medium was produced in the same way as in Examples 1 to 4, except that: the first hardening resin layer 3 and a signal pattern surface of the substrate 1 with the reflective layer 2 formed thereon were arranged so as to oppose each other and were stacked, and the polyethyleneterephthalate film was peeled off, whereby the first hardening resin layer 3 in a semi-hardened state was formed on the substrate 1. The thickness of the first hardening resin layer 3 was 25±0.5 μm. Further, the optical recording medium was reproduced with laser light of 405 nm, whereby signal characteristics of high quality with a jitter of 4 to 6% and a signal noise of −70 to −80 dB were obtained. It is considered from the result that a signal pattern was transferred satisfactorily in the above-mentioned optical recording medium.

According to Examples 5 to 8, the first hardening resin layer excellent in thickness uniformity can be formed without using a thickness enhancing method such as sealing a center hole by spin coating, whereby the productivity can be enhanced. Further, the process of coating the reflective layer or the recording layer with an unhardened resin is not required, so the influence such as degradation of the reflective layer or the recording layer by the unhardened resin can be prevented, which enables production of an optical recording medium of high quality.

As described above, according to the present invention, an adhesive layer or a hardening resin layer with a signal pattern surface is formed using a hardening resin containing at least two kinds of photopolymerization initiators having different absorbing wavelength ranges, whereby the hardened state of the adhesive layer or the hardening resin layer can be controlled step-wise. Thus, a hardening resin layer in a semi-hardened state with limited flowability can be formed, and the thickness uniformity of the hardening resin layer to be formed finally can be enhanced. By performing complete hardening in a later process, an optical recording medium of high quality can be produced easily without defects such as spreading of a resin or contamination of air bubbles. Further, the hardened state of the hardening resin is controlled, whereby the hardening resin layer in a semi-hardened state with a signal pattern formed thereon is attached to a substrate and is then peeled off easily from the substrate by being completely hardened, leading to enhancement of productivity of an optical recording medium with a multi-layer structure. Further, since the hardened state can be controlled, the adhesive layer can be brought into contact with the substrate, the recording layer, or the reflective layer to be an adherend in a semi-hardened state. This can prevent the reduction in adhesion of an adherend with the adhesive layer caused by the formation of a semi-hardened state.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-128398, filed May 2, 2006, which is hereby incorporated by reference herein in its entirety.

What is claimed is:

1. An optical recording medium, comprising:
a substrate;
one of at least two recording layers and at least two reflective layers stacked on the substrate; and
a hardening resin layer that is hardened by irradiation of light, stacked between one of the at least two recording layers and the at least two reflective layers,
wherein the hardening resin layer contains at least two kinds of photopolymerization initiators.

2. A method of producing an optical recording medium having one of a plurality of recording layers and a plurality of reflective layers, comprising the steps of:
(1) forming one of a first recording layer and a first reflective layer on a substrate having a first signal pattern surface;
(2) forming a hardening resin layer containing at least two kinds of photopolymerization initiators having different absorbing wavelength ranges on one of the first recording layer and the first reflective layer;
(3) irradiating the hardening resin layer with a first energy line, thereby forming a hardening resin layer in a semi-hardened state;
(4) stacking a stamper on the hardening resin layer in the semi-hardened state;
(5) irradiating the hardening resin layer in the semi-hardened state with a second energy line to harden the hardening resin layer, thereby forming a hardening resin layer having a second signal pattern surface;
(6) forming one of a second recording layer and a second reflective layer on the hardening resin layer having the second signal pattern surface; and
(7) forming a protective layer on one of the second recording layer and the second reflective layer.

3. A method of producing an optical recording medium having one of a plurality of recording layers and a plurality of reflective layers, comprising the steps of:
(1) forming one of a first recording layer and a first reflective layer on a first signal pattern surface on a first substrate;
(2) forming one of a second recording layer and a second reflective layer on a second signal pattern surface on a second substrate, in which a surface of the second substrate opposite to the second signal pattern surface is a flat surface;
(3) forming a hardening resin layer containing at least two kinds of photopolymerization initiators having different absorbing wavelength ranges on any of the first recording layer, the first reflective layer, second recording layer, and the second reflective layer;
(4) irradiating the hardening resin layer with a first energy line, thereby forming a hardening resin layer in a semi-hardened state;
(5) stacking one of the first recording layer and the first reflective layer on one of the second recording layer and the second reflective layer via the hardening resin layer in the semi-hardened state; and
(6) irradiating the hardening resin layer in the semi-hardened state with a second energy line, thereby hardening the hardening resin layer.

4. The method according to claim 3, further comprising the steps of peeling the second substrate and forming a protective layer on one of the second recording layer and the second reflective layer after the step (6).

5. A method of producing an optical recording medium having one of a plurality of recording layers and a plurality of reflective layers, comprising the steps of:
(1) forming one of a first recording layer and a first reflective layer on a first signal pattern surface on a first substrate;
(2) forming one of a second recording layer and a second reflective layer on a second signal pattern surface on a second substrate, in which a surface of the second substrate opposite to the second signal pattern surface is a flat surface;
(3) forming a hardening resin layer containing at least two kinds of photopolymerization initiators having different absorbing wavelength ranges on any of the first recording layer, the first reflective layer, and the flat surface;
(4) irradiating the hardening resin with a first energy line, thereby forming a hardening resin layer in a semi-hardened state;
(5) stacking one of the first recording layer and the first reflective layer on the flat surface via the hardening resin layer in the semi-hardened state;
(6) irradiating the hardening resin layer in the semi-hardened state with a second energy line, thereby hardening the hardening resin layer; and
(7) forming a protective layer on one of the second recording layer and the second reflective layer.

6. A method of producing an optical recording medium having one of a plurality of recording layers and a plurality of reflective layers, comprising the steps of:
(1) forming one of a first recording layer and a first reflective layer on a first signal pattern surface on a first substrate;
(2) forming a first hardening resin layer containing at least three kinds of photopolymerization initiators having different absorbing wavelength ranges on one of a stamper and a flat surface on a second substrate;
(3) irradiating the hardening resin layer with a first energy line, thereby forming a first hardening resin layer in a first semi-hardened state;
(4) stacking the stamper on the substrate via the first hardening resin layer in the first semi-hardened state;
(5) irradiating the first hardening resin layer in the first semi-hardened state with a second energy line, thereby forming the first hardening resin layer in a second semi-hardened state;
(6) peeling the stamper from the first hardening resin layer;
(7) forming one of a second recording layer and a second reflective layer on a signal pattern surface of the first hardening resin layer in the second semi-hardened state;
(8) forming a second hardening resin layer containing at least two kinds of photopolymerization initiators having different absorbing wavelength ranges on any one of the first recording layer, the first reflective layer, the second recording layer, and the second reflective layer;
(9) irradiating the second hardening resin layer with a third energy line, thereby forming a second hardening resin layer in a semi-hardened state;
(10) stacking one of the first recording layer and the first reflective layer on one of the second recording layer and the second reflective layer via the second hardening resin layer in the semi-hardened state;
(11) irradiating the first hardening resin layer in the second semi-hardened state and the second hardening resin layer in the semi-hardened state with a fourth energy line, thereby hardening the first hardening resin layer and the second hardening resin layer; and
(12) peeling the second substrate.

7. A method of producing an optical recording medium having one of a plurality of recording layers and a plurality of reflective layers, comprising the steps of:
(1) forming one of a first recording layer and a first reflective layer on a first signal pattern surface on a first substrate;
(2) forming a first hardening resin layer containing at least three kinds of photopolymerization initiators having different absorbing wavelength ranges on one of a stamper and a second signal pattern surface on a second substrate;
(3) irradiating the hardening resin layer with a first energy line, thereby forming a first hardening resin layer in a first semi-hardened state;
(4) stacking the stamper on the substrate via the first hardening resin layer in the first semi-hardened state;
(5) irradiating the first hardening resin layer in the first semi-hardened state with a second energy line, thereby forming the first hardening resin layer in a second semi-hardened state;
(6) peeling the stamper from the first hardening resin layer;
(7) forming one of a second recording layer and a second reflective layer on a signal pattern surface of the first hardening resin layer in the second semi-hardened state;
(8) forming a second hardening resin layer containing at least two kinds of photopolymerization initiators having different absorbing wavelength ranges on any one of the first recording layer, the first reflective layer, the second recording layer, and the second reflective layer;
(9) irradiating the second hardening resin layer with a third energy line, thereby forming a second hardening resin layer in a semi-hardened state;
(10) stacking one of the first recording layer and the first reflective layer on one of the second recording layer and the second reflective layer via the second hardening resin layer in the semi-hardened state;
(11) irradiating the first hardening resin layer in the second semi-hardened state and the second hardening resin layer in the semi-hardened state with a fourth energy line, thereby hardening the first second hardening resin layer and the second hardening resin layer;
(12) peeling the second substrate;
(13) forming one of a third recording layer and a third reflective layer on the first hardening resin layer; and
(14) forming a protective layer on one of the third recording layer and the third reflective layer.
